(19) United States
(12) Patent Application Publication
(10) Pub. No.: US 2013/0124653 A1
(43) Pub. Date: May 16, 2013

(54) SEARCHING, RETRIEVING, AND SCORING SOCIAL MEDIA

(71) Applicant: Loopa LLC, Orlando, FL (US)

(72) Inventors: Lance R. Vick, Orlando, FL (US); Hassan R. Seguias, Orlando, FL (US); Adam Christian Anderson, Orlando, FL (US)

(73) Assignee: Loopa LLC, Orlando, FL (US)

(21) Appl. No.: 13/679,437

(22) Filed: Nov. 16, 2012

Related U.S. Application Data
(60) Provisional application No. 61/560,609, filed on Nov. 16, 2011.

(51) Int. Cl. H04L 12/58

(52) U.S. Cl. CPC H04L 51/32
USPC 709/206

(57) ABSTRACT

Computer-implemented systems, methods, and computer-readable media for generating a social media score comprising: receiving a request for a score of an asset from a client computing device; receiving a plurality of posts from one or more social media networks relating to the asset; identifying a sentiment of each post; identifying a reach of each post; storing an identification of the asset, the sentiment of the post, and the reach of the post in association with each post in a dataset; generating a score for the asset, the score being a function of the sentiment the posts relating to the asset, the reach of the posts relating to the asset, and a volume of posts relating to the asset; and transmitting the score to the client computing device for display in a user interface.

### PRIORITY CLAIM

This application claims priority to the U.S. provisional patent application 61/560,609, filed Nov. 16, 2011, which is hereby incorporated by reference.

### BACKGROUND

The explosion of social media networks over the past few years has produced unprecedented amounts of user-generated content (e.g., blog posts, comments, Twitter Tweets), social media data (e.g., Facebook Friends and Likes, LinkIn Connections, Digg Diggs), and other similar data. These various data are referred to collectively as social media, social media content, or social media data herein. Social media has accelerated the rate that data and user opinions about a product, person, brand, digital content, topic of discourse, and the like (referred to collectively as assets) are spread. An influential person's Tweet or other social media post about an asset may “go viral” and within hours—if not minutes or seconds—spread around the world to the benefit or detriment of the asset. For example, President Obama may Tweet about an upcoming debate and moments later hundreds of thousands of followers may know to tune-in.

Because of its reach, social media greatly impacts peoples' knowledge and perception of assets. For example, a negative comment about a celebrity, politician, new product, and the like may spread like wildfire across social media networks. However, the vast amount of non-influential data (e.g., data without an influential message or data not from an influential source) available on social media networks may obscure influential messages. Users of social media networks are often unable to determine the overall message carried by the aggregate data.

To mitigate this problem, companies have attempted to show profiles or scores for people based on social media data. For example, Klout provides an “influence score” measuring a user's influence. This score is based on the size of a person's network, the content they create, and analytics of how other people interact with that content. However, while the Klout score may assist a user with finding people who are generally influential, it provides almost no assistance with finding data about a specific asset. Additionally, such a score fails to differentiate between data created by an influential person that is itself influential (e.g., a positive review of a movie) and the volumes of data created by the influential person that is not itself influential (e.g., what they had for breakfast).

Another difficulty presented by social media networks is that data may not be easily aggregated. Social media networks generally make their data available via application programming interfaces (“APIs”) with rate limits capping the number of requests a single connection or token may make within a set time period. For example, Facebook limits requests to one request per second. Similarly, Twitter only allows a single continuous request at a time only pulling one percent of the stream. These rate limits allow a normal user to login and interact with the social media networks with no perceivable limitations. However, for a service to aggregate social media typically a server or cloud of servers must connect directly to APIs to collect data on behalf of a requesting user and then send the collected data down a stream (e.g., via a PUSH protocol) to a requesting user's browser. The downside of this approach is that the APIs' rate limits prevent scalable systems. For example, if a thousand users accessing the aggregation service request a search at once, the backend server's requests would be limited by the APIs.

In an attempt to work around such limitations, companies such as GNIP and Radian6 have implemented systems having many servers independently make requests to APIs to allow greater amounts of data to be retrieved from social media networks while working within each network's rate limit. However, these designs only increase the data available from an API linearly with the number of servers (i.e., to be effective an independent server must be designated to each subscribing client). Thus, such systems must employ huge numbers of servers to distribute the requests. This has proven very costly.

Improved systems for scoring, aggregating, and otherwise utilizing social media are desired.

### BRIEF DESCRIPTION OF THE DRAWINGS

FIG. 1 illustrates an exemplary architecture for a computing system useful for implementing the embodiments disclosed herein.

FIG. 2 illustrates an exemplary process flow for scoring an asset.

FIG. 3 illustrates an exemplary process flow for evaluating a sentiment score for a post.

FIG. 4 provides a graphical illustration of the asset score as a function of the sentiment, reach, and volume of posts over a period of time.

FIG. 5 illustrates exemplary client driven transmissions for receiving data from plural social media networks.

FIG. 6 illustrates an exemplary process flow for one or more server computing devices to send a page to a client device, receive social media data from a plurality of social networks via the client device, and generate a social media score based on the received social media data.

FIG. 7 illustrates an exemplary process flow for one or more server computing devices to retrieve significant amounts of data from plural APIs while abiding by the APIs rate limits.

FIG. 8 illustrates an exemplary architecture for a system for providing a user with aggregated social media relating to an asset and a social media score for the asset.

FIGS. 9 through 16 illustrate exemplary user interface screens that may be rendered on a client device to view aggregated social media content relating to assets, social media scores for an assets, advertisements related to assets, profiles of assets, and the like.

FIG. 17 illustrates an exemplary computing device useful for implementing embodiments disclosed herein.

FIGS. 18 through 22 illustrate additional exemplary user interface screens that may be rendered on a client device to view aggregated social media content relating to assets, social media scores for an assets, advertisements related to assets, profiles of assets, and the like.

### DETAILED DESCRIPTION

Systems, computer-implemented methods, and computer-readable media disclosed herein may be useful for generating social media scores. Embodiments may generate comprehensive social media scores for companies, brands, individuals, services, digital content, or other assets based on social media relating to the assets. Embodiments may provide more useful information by generating a score of a specific asset rather than merely scoring a single person's influence. Further, by factoring into the score sentiment of comments, posts, Tweets, and other social media communications, a score may reflect not only how much activity (e.g., posts per second) or reach (e.g., followers of the person posting) a social media poster has, but may also reflect useful information about the content of the social media posts relating to the asset. Additionally, embodiments may employ a human element to continually improve score accuracy through both internal human review of sentiment determinations and external independent human contextual validation.

Embodiments may also provide systems, methods, and media for a server to acquire vast amounts of social media data through requests issued from client computing devices rather than directly from server computing devices. In this fashion, each request to a social media network's API comes from a separate internet protocol (“IP”) address, token, or other identifier, thereby avoiding rate limit caps. A single server computing device, by maintaining an open (e.g., WebSocket) connection with each client computing device, may issue requests from each client computing device to plural APIs utilizing the full rate limit of each API. Thus, servers may receive aggregate social media data at a much lower cost than currently employed methods.

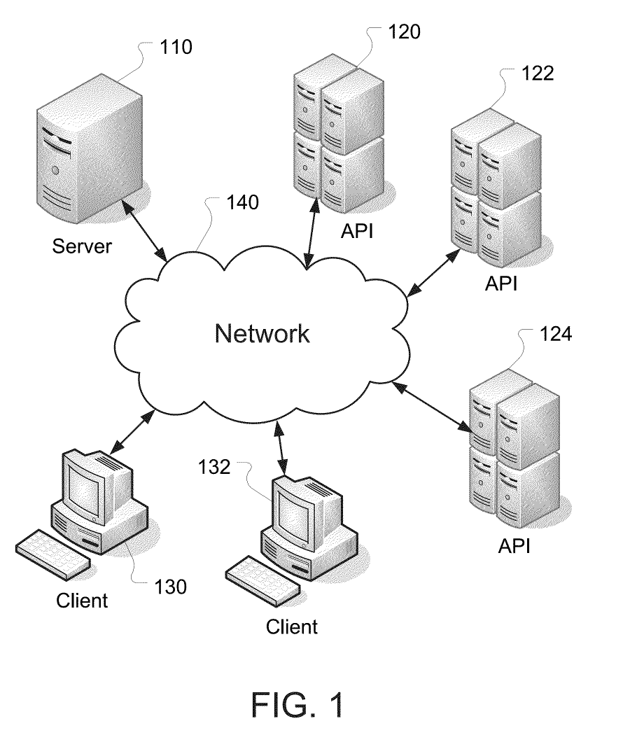

The following describes specific features of various embodiments in greater detail. To provide context to these embodiments, FIG. 1 illustrates an exemplary architecture for a computing system. In the computing system, several computing devices are coupled via one or more networks 140, such as the internet. A client computing device 130 may send a request to a server computing device, server 110, for example a request for a webpage showing aggregated social media relating to an asset and a score of the asset. In response, server 110 may send a page over the network to client 130. The page may include placeholders for a score of the asset and social media content relating to the asset. The page may be configured to cause client 130 to request social media from social media API 120, API 122, and API 124. The data client 130 received from the APIs may then be normalized and rendered directly into the page, may be sent to server 110 for further processing, and may be otherwise utilized. Server 110 may then process the data from client 130, generate a score for the asset, and send the score to client 130 for display in the page. Server 110 may handle requests received from client 132 or other clients in similar fashion.

Of course, FIG. 1 only illustrates one exemplary architecture for embodiments disclosed herein. For example, embodiments may utilize plural servers or cloud-based servers rather than a single computing device. Additionally, clients may be mobile devices such as smartphones (e.g., iOS based phones, Android based phones, etc.) or tablets, set top boxes, web-enabled TVs, and any other connected devices. Of course, not-yet-developed technologies and devices may also utilize embodiments disclosed herein.

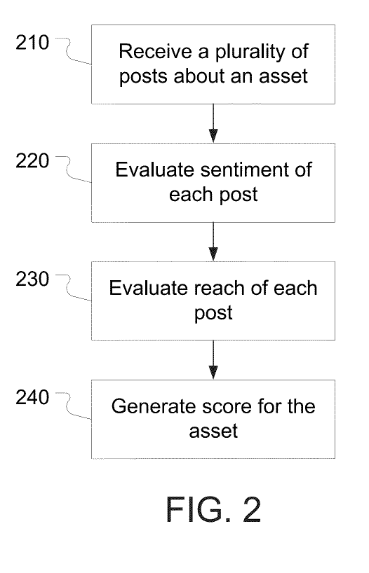

As mentioned above, embodiments may generate a social media score for an asset. Any asset that is the topic of social media posts may be scored. FIG. 2 illustrates an exemplary process flow for scoring an asset. At step 210, a computing device, such as the server 110 shown in FIG. 1, receives a plurality of social media posts about an asset (e.g., a topic). Posts may be, for example, posts on a user's Facebook Wall, Tweets, comments on an article, blog posts, or any other user generated content. Posts about an asset may be received in response to a search against an API for the asset. For example, a search of plural social media APIs for the asset “Android” may result in receiving a plurality of posts relating to the asset “Android.” In some embodiments, social media posts may be received directly from various social media networks' APIs in conventional fashion. In other words, one or more servers may transmit requests to the social media APIs directly to retrieve the posts. In other embodiments, social media posts may be received from a client computing device that itself directly receives social media posts from various social media networks' APIs as described below. Of course, social media posts may be received in any fashion that allows for timely receipt of posts while working within each network's rate limits.

Posts about an asset received from an API may include some posts that may be misclassified, for example due to limitations of Natural Language Processing (“NLP”). For example, a search of an API for the topic Android, referring to the operating system, may include posts relating to android, referring to the robot having a human appearance. Optionally, embodiments may include disambiguation or other processes to remove posts not related to the asset.

Once posts are received by the server, at step 220 a computing device evaluates the sentiment of each post. For example, NLP may be utilized by a computing device to analyze the text of each social media post. The NLP may utilize a Naüve Bayesian classification system to classify the text as either providing a positive, neutral, or negative sentiment. The Naïve Bayesian classification may, for example, use Python's Natural Language Toolkit (“NLTK”). The evaluation may include generating a sentiment score of each post (also simply referred to as the sentiment of a post herein). An exemplary sentiment score scale may provide a −1 for a post identified as completely negative, a 0 for a neutral post, a +1 for a completely positive post, and a positive or negative fractional score for intermediate sentiment determinations. Of course, the scale may be shifted (e.g., to all positive numbers), scaled (e.g., to provide a score from −100 to 100 but having no fractional scores), or otherwise modified according to design preferences.

In some embodiments, to evaluate the sentiment of each post a Naüve Bayesian classifier may first be trained on a data set of negative and positive posts. For example, Tweets may be determined to be positive or negative based on emoticon identifiers within the text. Functions may then be performed on the data set to normalize it and extract features (e.g., words or phrases). Normalizing the data may unify the data set and remove redundancies and meaningless text. For example, all text may be lowercased, re-Tweets and hash-tags may be stripped, URLs and HTML may be stripped, and the like. This produces a cleaner dataset with fewer discrepancies (e.g., APPLE and apple would be normalized to be the same).

Next, features extraction may be performed on the remaining features to determine a set of features (e.g., words, phrases, emoticons, etc.) that may be highly informative (i.e., features that are heavily biased towards one label). Features in a set of stop features may not be extracted as they may be deemed uninformative. For example, “and”, “this”, and “i” may be features in a set of stop features.

In some embodiments, only features in a set of informative features may be extracted. Features in the set of informative features may be features that have a high correlation to a particular label. Embodiments may provide two mutually exclusive labels—positive and negative. The word “i” may not be included in the set of informative features because it may appear many times in both positive and negative posts. In contrast, the word “amazing” may appear in the set of informative features because it likely has a high correlation to positive posts and thus is a strong indicator. A chi-squared distribution may be used to determine the set of informative features. A determined number (e.g., 10,000) of most informative features may be included in the set of informative features. Because there are only two labels for each feature, positive and negative, a resulting classifier may be a binary classifier.

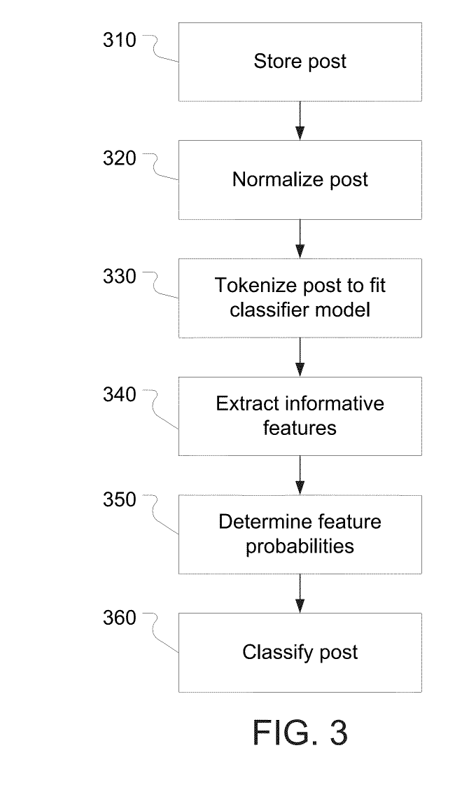

FIG. 3 illustrates an exemplary process flow for evaluating a sentiment score for a post. In step 310, a post may be stored in a data set along with a label of the post. For example, the post “@tsoporan I really like ICECREAM!!!” may be stored in a data set as {“@tsoporan I really like ICECREAM!!!”, “positive”}. At step 320, the post may be normalized. Continuing the example, the post may be normalized to “i really like icecream”. At step 330, the post may be tokenized to fit the classifier model. In this example, the post may be tokenized as {“i”:TRUE, “really”:TRUE, “like”:TRUE, “icecream”:TRUE}. At step 340, features may be extracted against the set of informative features. In this example, the word “i” will most likely occur in both sets of negative and positive, so the chi-squared distribution will determine that “i” is a meaningless word. This step increases classifier performance by excluding low-information noise. After feature extraction, the features for the example post may be {“like”:TRUE, “icecream”:TRUE}. At step 350, the process may determine probabilities of each of the extracted tokens using a Naüve Bayesian classification model. At step 360, the process may classify the text and give a score to the post. The score may range from −1 to 1 where −1 is entirely negative and 1 is entirely positive.

To interface with the classifier, a guesser may be utilized. The guesser may have a guess method that takes a string of text and performs classification on it. The guess method may take steps to normalize a post in similar fashion as the above-described normalization so that the classifier is fed consistently. An exemplary guesser may work as shown below:

>>> g = Guesser( ).guess( )
>>> g(“i really like icecream”)
>>> 0.683

In this example, the classifier returns a sentiment that is fairly positive. This may be the case where words like “really”, “like”, and “icecream” are determined to be positive, therefore resulting in a positive sentiment. The Naüve Bayesian classification takes each feature into consideration independently. The log probabilities for each label given the features may be determined then added together and scaled to reflect a score ranging from 0 to 1. The score may then be shifted, scaled, or otherwise adjusted to a −1 to 1 scale. Of course, the score may be scaled in alternative fashions based on design preferences.

The following is exemplary pseudo code for evaluating the sentiment of each post:

```
# Find the log probabilty of each label, given the features.
# Start with the log probability of the label itself.
logprob = { }
for label in labels
    logprob[label] = label_probdist.logprob(label)
    #Then add in the log probability of features given labels.
        for label in labels
            for (feature, value) in featureset
                if (label, feature) in feature_probdist
                    feature_probs = feature_probdist[label, feature]
                    logprob[label] += feature_probs.logprob(feature)
```

Alternative embodiments may evaluate the sentiment of posts in various other ways. For example, supervised-learning classification algorithms other than Naüve Bayesian classification may be used, such as the Maximum Entropy classifier. Alternatively, the MegaM optimization package or decision trees may be utilized. Still further, classifier voting, which involves training two or more classifiers and choosing the best accuracy between the two, may be used. Combinations and hybrids of these exemplary sentiment models may also be used.

Embodiments may also discount sentiment determinations where the sentiment is determined to be within a neutral range. In this fashion, sentiment may better express real-world accuracy—in the real world people would likely discount a nearly neutral statement regarding an asset. A threshold neutral range, for example, may include any sentiment determined to be between −0.2 and 0.2. Any post receiving a sentiment within the neutral range may then be discounted. Alternatively, any post receiving a sentiment within the natural range may receive a sentiment of 0.0 or 0.1 so that its nearly neutral sentiment does not greatly bear on the overall score. Such discounts may result in a tightening of the classifier which forces it to be more confident about the features it classifies.

Referring again to FIG. 2, in step 230 a computing device may evaluate the reach of each post. The reach of a post represents the estimated number of people that might see the post. For services that provide the information through their API, the number of people who see each post may be directly mapped. For example, on Twitter and Identica, the number of “followers” may be mapped. For services that do not provide the number directly, a best estimate may be calculated based on factors such as activity and global average, optionally taking into account only the larger factor. For example, if a Facebook user's Wall is not publicly available embodiments may assign the Facebook user's posts the value of the global average of Facebook Friends (e.g., 130). Continuing this example, if the Facebook user's Wall is publicly available and the user has Likes and comments on a threshold number of posts (e.g., the last 20 posts), the number of Likes and comments may be scaled by a scaling factor (e.g., 10). If the scaled reach is greater than 130 (i.e., the global average), the estimate (i.e., scaled reach) based on the public Facebook Wall data may be used as the reach. Otherwise, the global average may be used. While this example suggests a scaling factor of 10, alternative scaling factors may be used based on ratios of comments and Likes to Friends. Further, the scaling factor may change over time as ratios change or the scaling factor may be a variable function rather than a constant. The reach of a post may be evaluated on a scale from 0 to 1,000 with 1,000 having the greatest reach and 0 having the least. Of course, the reach may be shifted, scaled, or otherwise modified according to alternative designs.

Embodiments may determine reach globally or within a desired subset social media. For example, embodiments may utilize geotagging to determine the reach of a post within a geographical region. In such embodiments, each post may be geotagged based on IP clustering, HTML5, or any other method. The reach may then be determined considering the geolocation of the post.

Embodiments may also provide a ceiling value to cap the reach. For example, a 1,000 reach ceiling may be provided, thereby limiting the reach of posts that are distributed to more than 1,000 followers. For example, a post by President Obama may receive a reach of 1,000 even though over 11,000,000 followers may see the post. Such a cap may enforce reasonable scaling.

While in the exemplary process flow shown in FIG. 2 illustrates step 220 being performed before step 230, embodiments may perform the steps, or portions of the steps, in any order or in parallel. Additionally, similar process flows may be performed simultaneously for posts relating to different assets. The sentiment and reach of each post may be stored in association with the posts in a dataset, for example on a disk or in memory. The dataset may be, for example, a database on the server, stored in a cloud, stored in a data warehouse, or stored in any other retrievable fashion. Embodiments may allow access to the data according to some business models as described below. In addition to the sentiment and reach, each post may also be stored in association with additional metadata, for example the time the post was created, the time the post was received from the API, the social media network the post originated from, and the like.

In step 240, a computing device may generate a score for the asset. The score may be generated for an asset by first setting an accumulator, A, to zero. For each post, the sentiment, S, may be retrieved from the evaluation in step 220. Optionally, the sentiment may be set to a neutral value if the sentiment is determined to be within a neutral range (e.g., if −0.2<S<0.2, then S==0.1). For each post, the reach, R, may be retrieved from the evaluation in step 230. Optionally, if the reach value is greater than a ceiling, R may be capped to the ceiling value (e.g., if R>1000, then R==1000). For each post, the score, PostScore, may be determined as the product of the sentiment and the reach and then be added to the accumulator. This process may be repeated until a threshold number of posts have been scored or for a determined period of time, whichever comes first. In an exemplary embodiment, posts may be scored until 1,000 posts are processed or 10 minutes have passed, whichever happens first. Embodiments may also skip posts that have less than a threshold sentiment certainty. For example, post may be skipped if the sentiment has less than a 70% certainty.

Once the threshold number of posts has been scored, the average score of the posts may be determined by dividing the accumulator, A, by the number of posts accumulated, |P| (i.e., the cardinality of the set of posts P). Equation (1) below illustrates this function:

$$AvgScore = \frac{{\sum }_{p ∈ P} synt ( p ) * reach ( p )}{\vert P \vert} \qquad ( 1 )$$

Next, the volume of posts may be determined by dividing the number of posts by the time difference between the first post collected and the last post collected. Equation (2) below illustrates this function:

$$Volume = \frac{\vert P \vert}{time ( {p}_{f} ) - time ( {p}_{0} )} \qquad ( 2 )$$

The times may be measured in UNIX epoch time. A raw score for the asset may be determined by taking the product of the average score and the volume and dividing it by a constant. The constant, c, may affect the speed that a score moves up or down based on the posts involved in the score determination. In an exemplary embodiment, the constant may be set to 100 (i.e., c==100), however the constant may be adjusted according to design considerations. In other embodiments, the constant may be user specified to allow a user to control how fast scores change. In still other embodiments, the constant may be replaced by a variable function. Equation (3) below illustrates a raw score function:

$$RawScore = \frac{AvgScore * Volume}{c} \qquad ( 3 )$$

Finally, the social media score for an asset may be calculated according to the following equation (4):

$$AssetScore = 100 * \frac{arc tan ( RawScore ) + \frac{π}{2}}{π} \qquad ( 4 )$$

In equation (4), arctan uses radians. Equation (5) below illustrates the asset score purely as a function of the sentiment of each post, the reach of each post, and the times at which the posts were accumulated.

$$AssetScore = 100 * \frac{arctan ( \frac{{\sum }_{p ∈ P} synt ( p ) * reach ( p )}{c * ( time ( {p}_{f} ) - time ( {p}_{0} ) )} ) + \frac{π}{2}}{π} \qquad ( 5 )$$

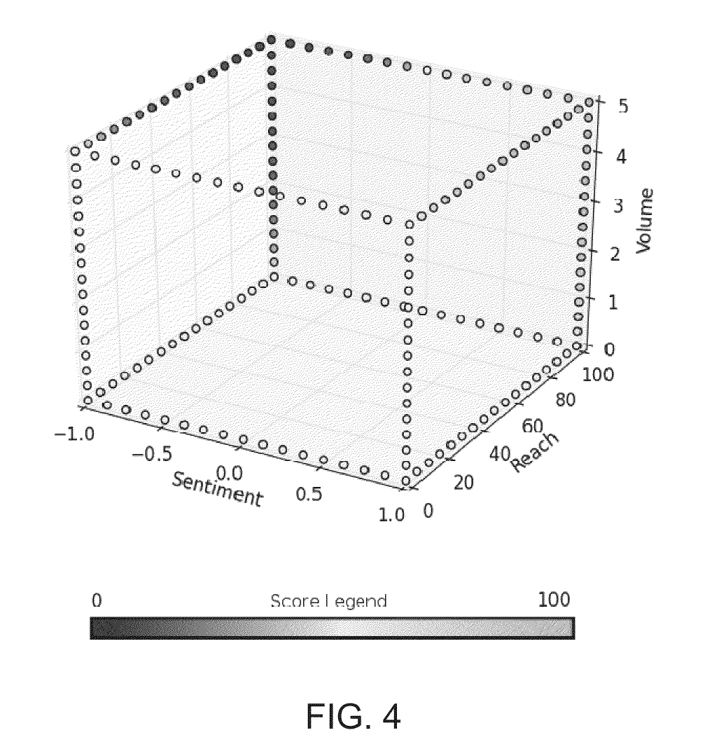

FIG. 4 provides a graphical illustration of the asset score as a function of the sentiment, reach, and volume of posts over a period of time.

Of course, alternative embodiments may determine asset scores in other ways as functions of the sentiment, reach, and volume of posts about a given asset. For example, an embodiment may determine an asset score according to equation (6) below.

AssetScore′=(S*R*V)^{1/3}*100 (6)

Another embodiment may determine an asset score according to equation (7) below.

$${AssetScore}^{′′} = \frac{( ( S * R ) + V )}{3500} \qquad ( 7 )$$

For equations (6) and (7), S is an average sentiment, R is an average reach, and V is a volume of posts about the asset for a determined period of time.

The above described embodiments generate asset scores based on posts accumulated over determined periods of time, either periods of time from a starting time until a determined number of posts are accumulated or posts accumulated within a determined time span. This may be desirable to illustrate the current score (i.e., real-time or near real-time score) of an asset. The score may be periodically (e.g., every determined number of seconds, minutes, hours, days, etc.) logged to allow asset score changes to be observed over time.

In alternative embodiments, the asset score may be based on all data collected about an asset or topic independent of the number of posts, the times the posts span, or both. For example, the dataset of posts about an asset may grow over time and the score may be based on all posts relating to the asset. In some embodiments, a user may select a timeframe for relevant posts relating to a topic to be scored. This may allow a user to retrieve a historic score for a period of time of interest.

Additionally, embodiments may derive further scoring data, such as the change in an asset's score over a period of time, high and low scores and their associated times, inflection points in the rate of change of a score, trending information, and the like. Embodiments may also flag specific social media posts that go viral, thus correlating to significant events relating to an asset's score or posters that have a significant effect on an asset's score. As will be discussed below, graphical models may be generated to provide user interface displays of scores and derived scoring data. Additionally, user interface controls may be provided to allow a user to drill-down within the score data to locate important posts, identity trends, identify social media networks having the greatest influence on an asset's score, and the like. Scores may also be stored with geotracking data and scores may be analyzed based on their geographic location. By way of example, geotracking data may be acquired via IP clustering or HTML5.

The process flow discussed with reference to FIG. 2 generates a score as a function of the number of posts accumulated within a time period, the sentiment of each post, and the reach of each post. In some embodiments all social networks are weighted equally. This may be advantageous because the reach of a given post may be more important than the reach of the social network on which it is posted. In other words, the estimated number of people who see the post may be a more important factor to consider than the number of people on a social media network who would not see the post. In such embodiments, weighting of social media networks may happen organically, as one service will have far more posts relating to a given asset than others. For example, there may be 100 Twitter posts about most topics for every Facebook post. Thus, all networks may be treated equally.

Alternative embodiments, however, may take additional variables into consideration when generating a score. For example, posts on one network may be weighted to be more influential than posts on another network (e.g., Facebook posts may be deemed more influential than Google+ posts because users may access the Facebook network more often to view the posts). By way of alternative example, the time and date of a post may be used to weight the significance of the post when calculating a score (e.g., post may have a time-date weight of 1 when initially posted and the weight may be reduced as a function of time).

Embodiments may include a continual improvement platform that enables real people to evaluate and validate the score and sentiment determinations of posts. The continual improvement platform may include, for example, internal human review systems as well as external independent human contextual validation systems. The human element input may thus inure to the benefit of all users of embodiments by providing for more accurate scores.

Systems or methods for external independent user validation of the accuracy of the determined sentiment of posts may be employed in any of the embodiments disclosed herein, thus incorporating an external human element. For example, a website may make posts (e.g., randomly selected posts) available for users to flag as having negative, positive, or neutral sentiment. If a post is classified the same way by three anonymous users seeing the post at random, then the verdict may be deemed trustworthy and the post may be classified according to the anonymous classifications if the classifications are positive or negative, or may be removed from consideration if the classifications are neutral. Post validations may be required to be from different IP addresses, subnets, or the like to ensure that a single user does not have too great an influence on the sentiment determinations. The sentiment classifier may also be periodically retrained based on the new sentiment validation data refined by the human element.

Embodiments may provide a benefit by both providing an internal editorial process and an external user input that continually improves the validity of the algorithm which products the score. Embodiments may also require posts having at least a threshold bearing on an asset's score to be validated by a determined number of independent users before allowing the post to be considered in calculating the score. For example, this may prevent a rave review from an influential person that contains an idiom from being mischaracterized as bashing the asset. Such a mischaracterized post that should raise an asset's score may mistakenly decrease the score. Validation of sentiment determinations may also be used to train algorithms to organically improve the automatic sentiment determinations over time.

Embodiments may also provide users with an ability to flag post sentiment determinations as erroneous in a post viewing interface. For example, when a person searches for posts related to a specific asset, posts may both show a determined sentiment value and a control (e.g., user interface button) to allow the user to flag the sentiment determination as incorrect. Because the user searching for a specific asset may have a pre-conceived bias for or against the asset, data relating to such flags may be stored in a dataset for manual consideration. Thus, internal and external human elements may be used in conjunction to provide unprecedented score accuracy.

Open source platforms may be utilized to allow transparency and to allow third parties to assist with improving quality, reliability, flexibility, and speed of the embodiments. The open source platform, especially in combination with both the internal editorial process and an external user input that continually improves the validity of the algorithm may allow embodiments to organically and continually improve at unprecedented rates. Such a living system may evolve to not only become more accurate, but also to naturally align itself with changing forms of communication and media.

As mentioned in the background, current servers are severely limited by the rate limits employed by social media networks' APIs. Thus, currently a single server cannot effectively collect data at one point and stream it to many requesting users for any number of assets. In contrast to conventional systems, embodiments may utilize systems and methods to connect to plural social media networks via a client computing device's browser. Thus, a client's browser may make requests to plural networks and pull the data in directly to the browser over that user's network connection. Because the requests are being submitted to each social media network directly from the client, the requests appear the same as standard requests (e.g., a browser widget request) that respect the API limits. As the social media data is being collected from the social media networks, the client may send the data as it comes in to the server for analysis and further processing. In order for social networks to deny such embodiments access, they would have to deny access to the users themselves.

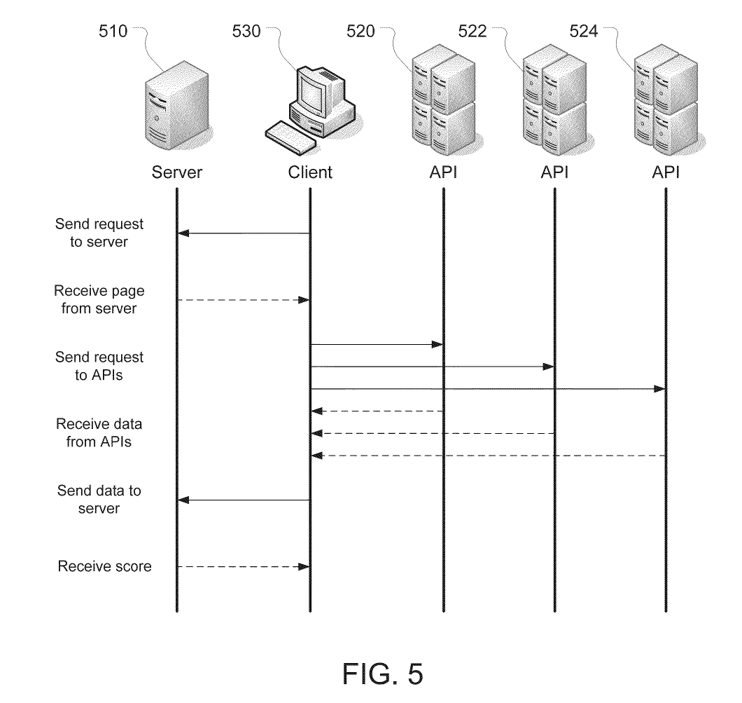

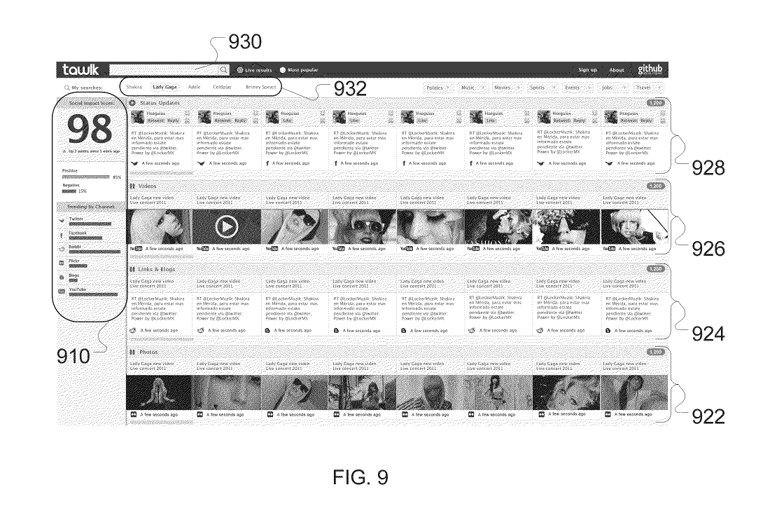

FIG. 5 illustrates exemplary client driven transmissions for receiving data from plural social media networks. A client 530 may send a request to server 510. For example, client 530 may request a page from server 510 including both a social media score of a user specified asset and content from plural social media networks relating to the asset. In response, the server may open a bi-directional connection with client 530, for example a WebSocket connection. At this point server 510 may transmit a page with placeholders for inserting social media content and a score. The page may be configured (e.g., via JavaScript code) to connect to a plurality of social media network APIs 520, 522, and 524 (e.g., Facebook, Twitter, etc.) and pull the social media data into client 530's browser. While FIG. 5 illustrates a single request to each API, embodiments may include plural calls to each API according to the API's requirements. Thus, each user's IP address, user token, or other identifier may be used to access each of the networks. Public posts relating to a specified asset and private posts as available (e.g., based on the user's token) may be retrieved. The data may then be normalized and inserted directly into the webpage on the client device for display to a user. FIG. 9 discussed below illustrates an exemplary page displaying content from plural social media network APIs.

Normalization may be performed according to any standard format that creates uniformity across posts. The following is exemplary pseudo code for normalizing posts from various networks:

| | |
|---|---|
| { | |
| “service” : “”, | # Service Name. |
| “user” : { | # User Info |

| | |
|---|---|
| “name” : “”, | # User Name |
| “real_name” : “” | # Real name of user |
| “id” : “”, | # Unique User ID |
| “language”: “”, | # Spoken language of user |
| “utc” : “”, | # UTC time offset of user |
| “geo” : “”, | # Latitude/Logitude User location |
| “description” : “”, | # User profile description |
| “avatar” : “”, | # Direct href to avatar image |
| “location”: “”, | # Plain Language User location |
| “subscribers”: “”, | # Number of subscribers |
| “subscriptions”: “”, | # Number of subscriptions |
| “postings”: “”, | # Number of postings made |
| “profile”: “”, | # Href to user profile |
| “website”: “”, | # Href to user website |
| } | |

| | |
|---|---|
| “to_users” { | # Attached link(s) |

| | |
|---|---|
| “0”: { | # Index of link |

| | |
|---|---|
| “name” : “”, | # User Name |
| “id” : “”, | # Unique User ID |
| “service” | # Name of service/Domain hosting link |
| “title” : “”, | # Title of item |
| “thumbnail” : “”, | # Direct href to thumbnail for item |
| “href” : “”, | # Direct href to item |
| }, | |
| }, | |

| | |
|---|---|
| “links” { | # Attached link(s) |

| | |
|---|---|
| “0”: { | # Index of link |

| | |
|---|---|
| “service” | # Name of service/Domain hosting link |
| “title” : “”, | # Title of item |
| “thumbnail” : “”, | # Direct href to thumbnail for item |
| “href” : “”, | # Direct href to item |
| }, | |
| }, | |

| | |
|---|---|
| “id” : “”, | # Unique ID |
| “geo” : “”, | # Latitude/Longitude content creation location |
| “application” : “”, | # Application used to create this posting |
| “location” : “”, | # Plain Language content creation location |
| “date” : “”, | # Date posted |
| “source” : “”, | # User friendly link to content |
| “text” : “”, | # Micro-blog text / Video Title / Etc |
| “description” : “”, | # Full post text / Description |
| “keywords” : “”, | # Related Keywords |
| “category” : “”, | # Category of content |
| “duration” : “”, | # Duration of content (if video) |
| “likes” : “”, | # Number of users who “liked” this |
| “dislikes” : “”, | # Number of users who “disliked” this |
| “favorites”: “”, | # Number of users who “favorited” this |
| “comments”: “”, | # Number of users who “commented” this |
| “rates”: “”, | # Number of users who “rated” this |
| “rating”: “”, | # Average “rating” of content |
| “min_rating”: “”, | # Minimum “rating” of content |
| “max_rating”: “”, | # Maximum “rating” of content |
| } | |

The normalization allows embodiments to treat posts in the same fashion regardless of what service (i.e., social network) they come from. Normalization allows embodiments to simulate a unified API as multiple networks can have their values remapped to a standard format. In the context of FIG. 5 described above, the posts received by the browser of 530 may be normalized and appear to be from a unified API rather than from multiple APIs (e.g., 520, 522, 524) each having their own proprietary data format.

Normalization allows modules of embodiments to work with uniformly formatted data independent of the data source. If not for normalization, special exceptions would be necessary in every library for every service for the vastly different API formats of different services. Some services may require multiple API calls to make up this format while others take only one. This is a limitation of current social network libraries that only support a single service. The normalization format employed by embodiments allows for embodiments to pull data from additional data services (e.g., social media networks) without modification of modules for determining the sentiment, score, aggregating content, and the like.

In addition to being useful for allowing client 530 to conveniently receive data from a plurality of social networks, embodiments may also analyze or perform additional processing of the social media data, for example to calculate a social media score taking into consideration the newly received data. While data is being collected via client 530 from APIs 520, 522, and 524, the data may be streamed via the open bi-directional connection back to server 510. Server 510 may then analyze each individual post (e.g., determine the above described sentiment, reach, and frequency of each post) to generate a score. The score may be generated based solely on the currently received social media data or may be a function of previously analyzed data. The server may then send the score to the client and the score may be displayed in the page for viewing by a user. This constant flow may only add a few milliseconds of delay to loading a page while allowing users to receive live scores for a requested assets and social media content aggregated and normalized from plural networks.

The process flow described above may allow for live scoring of assets to provide a user with a substantially real-time social media score of an asset. In alternative embodiments, a server may predetermine social media scores for a set of popular assets. In this fashion bandwidth and processing capacity may be utilized to provide near real-time social media scores for popular assets.

Embodiments may include redundancies to prevent a single malicious user from manipulating the open bi-direction connection (e.g., WebSocket API) by sending garbage data (i.e., data poisoning) to manipulate an asset's social media score. For example, embodiments may trust only data that has been received from at least a threshold number of users (e.g., two or three). The users may additionally be required to be independent (e.g., having different IP addresses or different identifying factors). Embodiments may also require at least a threshold number of posts to have been received about the asset (e.g., 500 posts). In such embodiments, any asset that has received a threshold number of posts from a threshold number of independent users may be scored.

For assets that users are not often searching for, embodiments may directly issue requests to the social media networks for data relating to the asset. While such requests may be subject to the severe rate limits of the respective networks' APIs, such data may be useful for supplementing or authenticating users' searches.

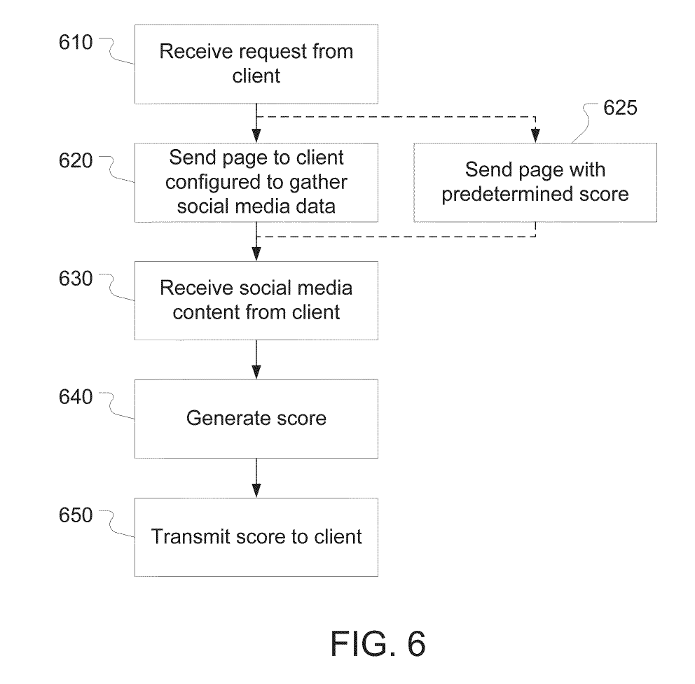

FIG. 6 illustrates an exemplary process flow for one or more server computing devices to send a page to a client device, receive social media data from a plurality of social networks via the client device, and generate a social media score based on the received social media data. In step 610, a server may receive a request from a client for a page relating to a specific asset, the page including at least one of a social media score for the asset and aggregated social media content relating to the asset. At step 620, the server may transmit a page to the client. The page may include one or more placeholders for insertion of a score and social media content. The page may also be configured to, upon being loaded in a client's browser, connect to a plurality of social media networks to pull social media content relating to the specific asset, normalize received social media content relating to the specific asset, and transmit the normalized social media content about the asset to the server. At step 630, the server may receive the normalized social media from the plurality of networks from the client. In alternative embodiments, the page may not be configured to normalize the social media content and the server may receive non-normalized social media content from the plurality of networks. At step 640, the server may generate a score for the specified asset, for example by performing the steps set forth in the process flow discussed above with reference to FIG. 2. At step 650, the server may transmit the score to the client for insertion in a placeholder in the page. Thus, within a few milliseconds of transmitting a request for a page relating to the specified asset, a user may see on a client device a page including a stream of aggregated social media content relating to the specified asset and a substantially real-time score of the asset.

In alternative embodiments, at step 625 the page sent from the server may include a previously determined score. In this fashion, the page may appear to fully load. Independent of whether the score is included in the page initially sent from the server, the server may periodically or aperiodically update the score as new social media content is received and processed.

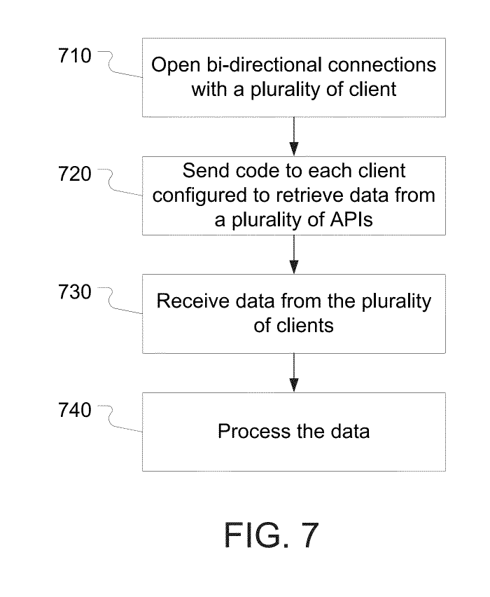

FIG. 7 illustrates an exemplary process flow for one or more server computing devices to retrieve significant amounts of data from plural APIs while abiding by the APIs rate limits. In step 710, one or more server devices may open a bi-direction connection with each of a plurality of clients. At step 720, the one or more server computing devices may send code to each client configured to be executed in the client's browser. When the code is executed in the client's browser, the client's browser may retrieve data from each of a plurality of APIs. In this fashion, each of the clients connected to the server may retrieve data from each API up to the rate limit of the API. The client's browser may then automatically transmit data received from each API back to the one or more server computing devices as the data is received from the API. The data may be normalized to appear as if it were received from a single, unified API. At step 730, the one or more computing devices may receive the data from each of the plurality of clients. At step 740, the one or more server computing devices may then process the received data.

While FIG. 7 illustrates a linear progression of discrete steps, embodiments may perform the steps in parallel with various clients configured to retrieve data from various APIs. By utilizing a plurality of clients in this fashion, the one or more server devices may quickly and inexpensively retrieve vast amounts of data from the various APIs.

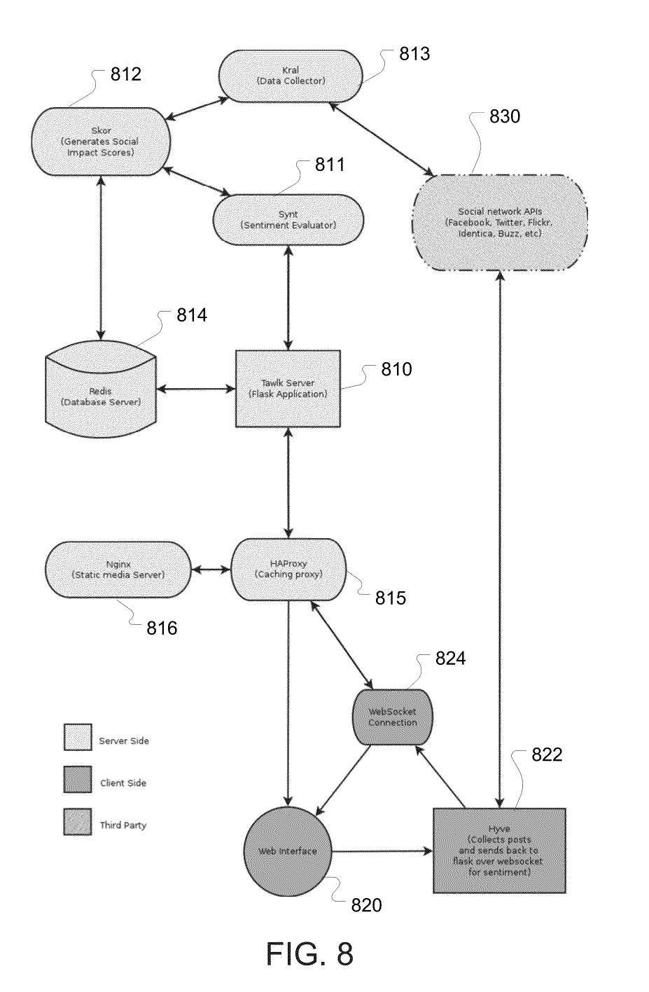

The above process flow for scoring posts, described in reference to FIG. 2, and process flow for one or more computing devices to receive social media data from a plurality of social media networks, described in reference to FIG. 6, may be combined with other modules to implement a system for providing a user with aggregated social media relating to an asset and a social media score for the asset. FIG. 8 illustrates an exemplary architecture for such a system. In FIG. 8, Tawlk server 810 may be a module that acts as a primary API server responsible for storing and accounting for collected data, running Social value sc[K]ORing engine (“Skor”) module 812 as needed, running social media c[K]RAwLer (“Kral”) module 813 as needed, running social Se[Y]NTiment classifier (“Synt”) module 811 on data from clients and sending the sentiment-calculated posts back to the client, and the like.

The Synt module 811 may be configured to evaluate the sentiment of a received post. Tawlk server 810 may send posts received from WebSocket connection 824 to Synt module 811 to have the sentiment of each post determined. The Synt module 811 may then return the sentiment of the post to Tawlk server 810 to be sent back to the user for display with the post. Synt module 811 may also transmit the posts and sentiment values to Skor module 812 so that the sentiment values may be used to generate a social media score for an asset. Synt module 811 may also be configured to receive posts from Skor module 812 and to return sentiment of each post.

The Skor module 812 may be configured to generate a score for a post based on the sentiment determination. Skor module 812 may receive posts either from the WebSocket connection 824 or from Kral module 813. For example, posts accessed by a user may be received via WebSocket connection 824. If additional posts to validate the posts received via WebSocket connection 824 are required or if no posts about an asset are received from WebsSocket connection 824, then Kral module 813 may send requests directly to APIs. When Skor module 812 receives such data directly from Kral module 813, Skor module 812 may forward the data to Synt module 811 to have its sentiment evaluated. Independent of the source of data received by Skor module 812, Skor module 812 may generate social media scores for assets and store the social media scores in Redis database 814.

Kral module 813 may be configured to receive social media posts related to an asset from one or more social media networks' APIs up to the rate-limit of each network's API. Kral module 813 may additionally be configured to normalize the received social media posts so that posts appear to have come from a single, unified API. In this fashion, server-side modules may handle posts in the same fashion independent of the social media network they are received from.

Embodiments may also include a HAProxy module 815 to provide a front end caching proxy for Tawlk server 810 to speed up client access. Nginx module 816 may provide static media to HAProxy module 815.

In response to receiving a request from a client device, HAProxy module 815 may transmit a page to a client to create a web interface 820. The web interface may also include code to open a bi-direction WebSocket connection 824 to allow data to be transmitted between server side modules and client side modules. The page may also include code to be executed as Hyve module 822 which is configured to collect posts relating to a specified asset from plural social media APIs and send the posts back to the server side modules in a normalized format via the WebSocket connection 824. Web Interface 820 may be configured to receive the social media posts retrieved by Hyve module 822 from WebSocket connection 824 and to render the posts in the Web Interface 820. Web Interface 820 may also be configured to receive sentiment evaluations of posts and social media scores of assets and to render such evaluations and scores in a user interface.

Social network APIs 830 illustrate APIs that may be provided by any social media network. Krawl module 813 and Hyve module 822 may collect posts and other data relating to an asset from each API. Krawl module 813 and Hyve module 822 may then normalize the received data so that it has a unified format for processing by server side modules.

FIGS. 9 through 16 illustrate exemplary user interface screens that may be rendered on a client device to view aggregated social media content relating to assets, social media scores for an assets, advertisements related to assets, profiles of assets, and the like.

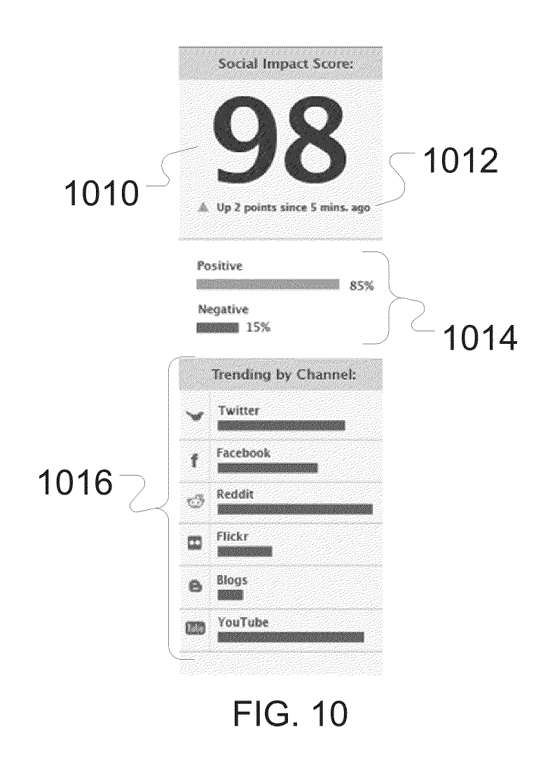

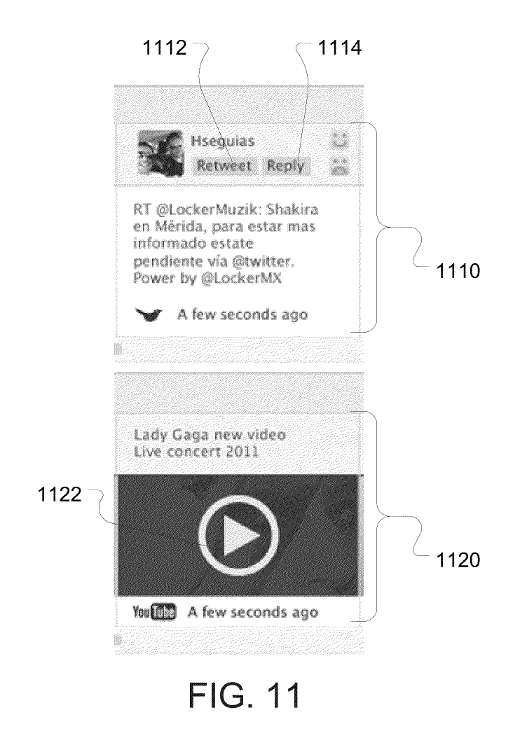

FIG. 9 illustrates an exemplary user interface (“UI”) for a social media system. For example, the UI of FIG. 9 may be provided by web interface 820 described with reference to FIG. 8 above. The UI may include a search box 930 configured to allow a user to search for social media posts related to an asset of their choice. Alternatively, the UI may include selectable search controls 932 to allow a user to select a popular asset. The UI may also display aggregated social media posts from a plurality of networks. For example, channel 928 shows status updates including Facebook and Twitter posts, channel 926 shows videos including YouTube videos, channel 924 shows links and blog posts, and channel 922 shows photos including Flickr photos. Each post may include various controls for viewing and interacting, which is described in greater detail with reference to FIG. 11 below. Each channel may automatically update to display new posts as they are created. For example, new posts may be displayed from the right and older posts may be shifted to the left, with the oldest posts being purged from the display as newer posts appear. Embodiments may include minimum time periods for displaying each post so that posts do not simply whiz by if there is significant activity relating to an asset. Embodiments may provide users with the ability for users to throttle or otherwise control the rate of speed of the display. FIG. 9 also includes a score section 910 which is described in greater detail below with reference to FIG. 10.

FIG. 10 illustrates score section 910 of FIG. 9 in greater detail. It includes social impact score 1010 which may be a score generated according to the process flow described above with reference to FIG. 2. Trend indicator 1012 may indicate trending information regarding the score, for example how the score has changed in recent minutes. Sentiment details 1014 may provide a breakdown of the sentiment of evaluated posts. In this embodiment, because the sentiment is shown to be 85% positive and 15% negative, the positively scored posts must have greater influence than the negatively scored posts to support the 98 social impact score. The UI also indicates trending by channel 1016 which provides a graphical representation of the impact of posts relating to the asset from various sources.

FIG. 11 shows a portion of the UI shown in FIG. 9 in greater detail. Post 1110, a Twitter Tweet, includes the content of the post as well as controls relating to the tweet to re-Tweet 1112 or reply 114. By providing the controls directly in the post, a user may interact with posts in the UI. In the video context, post 1120, a YouTube video, includes a play control 1122 to allow a user to play the video within the UI. Of course, posts from other social media networks may include other controls to allow a user to fully interact with posts.

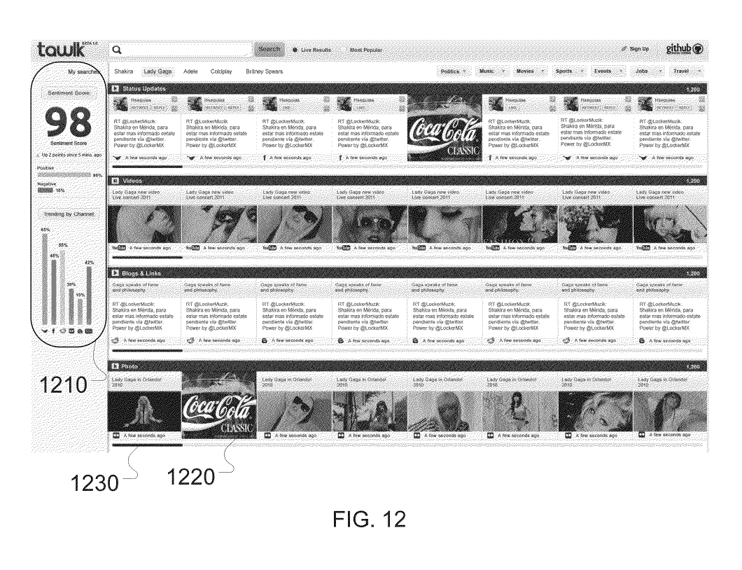

FIG. 12 illustrates an exemplary user interface (“UI”) for a social media system. This UI shows a score section 1210 having a design slightly different from score section 910 shown above. FIG. 12 also includes user interface controls 930 to allow a user to browse historic posts (e.g., new posts may appear from the left, but a user may scroll the bar to the right to view older posts). Additionally, FIG. 12 shows that ads 1220 may be displayed along with the content.

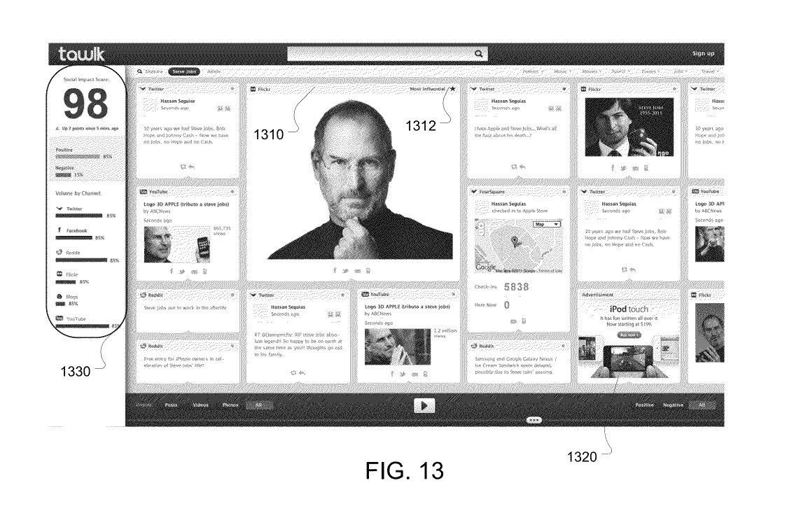

FIG. 13 illustrates an alternative exemplary user interface. In this user interface, posts may be displayed as floating windows and may scroll from one side of the screen to the other as new posts are received by the browser. The posts may include information about their impact or sentiment, for example a Flikr post 1310 includes a most influential indicator 1312. Additionally, this UI illustrates that directed advertisements may be displayed, such as ad 1320 for an iPod touch when a search for Steve Jobs is performed.

FIG. 13 illustrates a score section 1330 similar to the above described UIs, however alternative embodiments may include a score section as illustrated in FIG. 14. FIG. 14 includes a message 1410 indicating that a score is not available for the searched keyword. In some embodiments, only sponsored assets and associated keywords may have scores displayed on the UI. IN alternative embodiments, only users who pay a membership fee, have an account, or meet some other qualification may be able to view scores. Embodiments may optionally provide some features described herein without including others. For example, the sentiment, volume, and reach for an asset, such as “Steve Jobs,” may be shown to a user who does not have access to the score for the same asset.

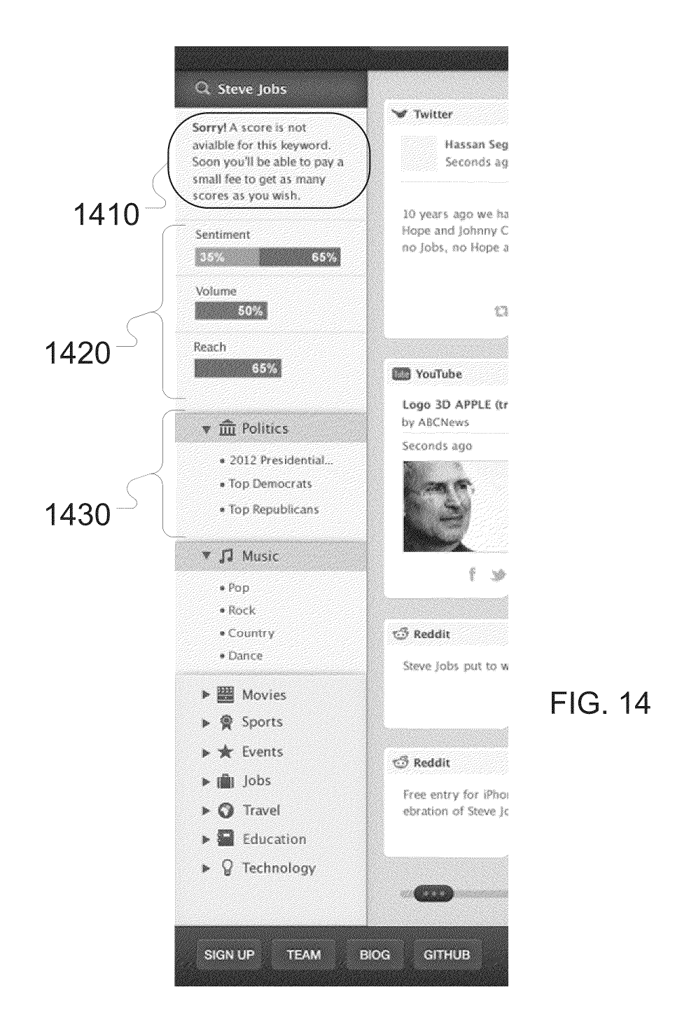

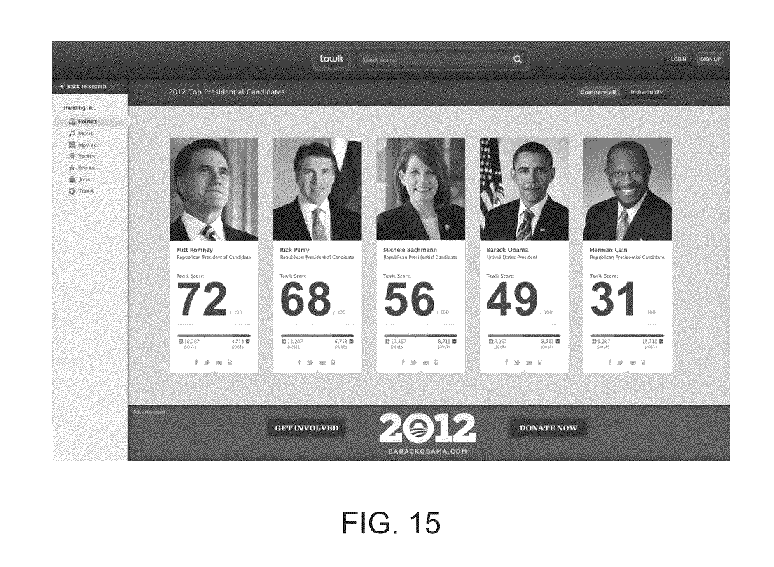

Embodiments may also provide UI controls to popular assets, groupings of assets, comparisons of assets, and the like. For example, politics UI controls 1430 may allow users to navigate to comparisons of assets relating to the 2012 presidential campaign or any future presidential or political campaign. FIG. 15 illustrates an exemplary UI showing real-time scores of the 2012 top presidential candidates. Embodiments are not limited to the specific views displayed herein, but may provide any type of display or reporting of aggregated social media content, scores of the social media content, and statistics or other data derived from the social media content.

The above user interfaces include both search boxes and selectable buttons for search for posts and scores related to assets. In some embodiments, asset scores may only be provided for specific assets. For example, posts may be aggregated to generate social media scores for popular assets, such as Mitt Romney, President Obama, Lady Gaga, Steve Jobs, and the like, and only those assets may be accessed from the UI. In other embodiments, a user may be able to enter any asset in the search box and a real-time or near-real time retrieval of social media posts may allow for determination of a social media score.

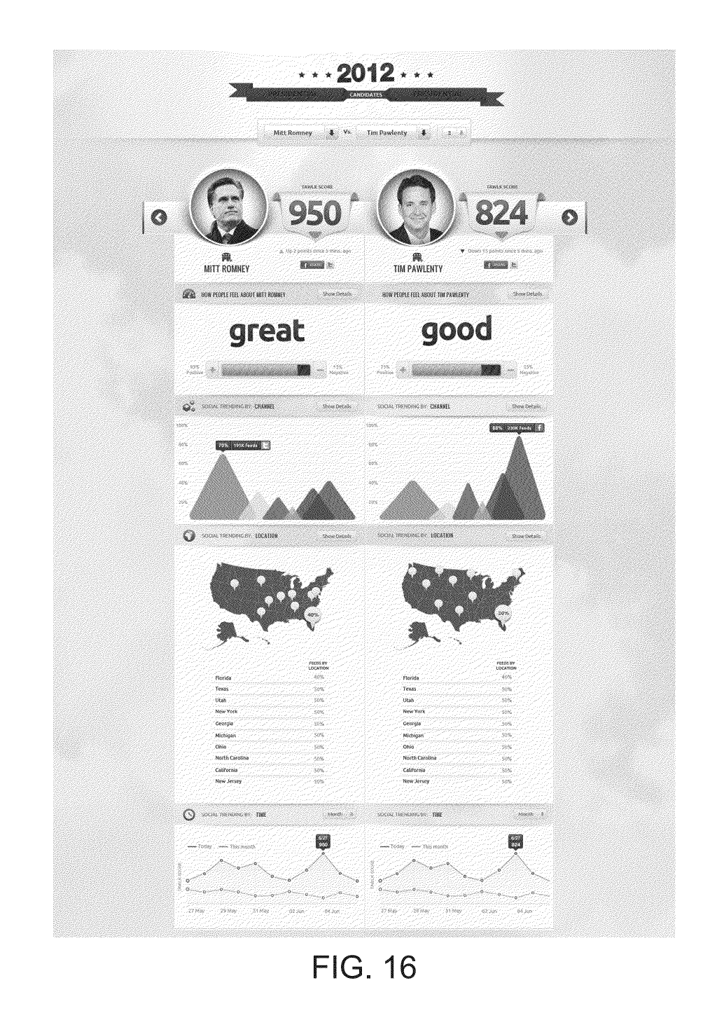

FIG. 16 illustrates an exemplary UI illustrating a social media profile for an asset as well as a social media comparison of assets. As shown, embodiments may be configured to display a comparison of social media scores for plural assets, such as plural candidates in an election. Embodiments may also show many statistics relating to the social media score of each asset, for example geographic breakdowns of social media posts for or against the asset, a breakdown of networks on which posts about the asset are found, trending information, analysis of the social media score of the asset over time, and the like. Some assets may have particular profiles configured to illustrate useful information relevant to the asset that may not be relevant to other assets. For example, a profile for a presidential candidate asset may provide detailed information showing which states social media posts originated from more refined geographic areas as well as social media channel information. An alternative profile for a world cup team asset may provide detailed information showing which countries social media posts originated from.

FIG. 16 also illustrates that in some embodiments assets may encompass sub-assets. For example, a social media profile for the asset 2012 republican presidential candidacy may include social media posts and scores for plural candidate assets relevant to the republican presidential candidacy. Embodiments may be flexible to allow any assets to have defined profiles configured to display useful social media data, scores, related statistics, and the like.

In the above described embodiments, once a page is received by a client and executed in the client's browser, various functions may be performed. These may include opening a bi-direction connection with the server to transmit social media data retrieved from plural APIs and for receiving sentiment evaluations and scores and issuing requests to plural APIs to retrieve social media content relating to desired assets. Embodiments may be configured to utilize HTML5 to allow the functionality to be performed from the client side even if one or more of the connections goes down. For example, in the context of FIG. 8 described above, if the server side modules go down after the page is loaded on the client, the Hyve module 820 may continue to retrieve social media relating to an asset from social network APIs 830 and WebSocket connection 824 may continue to send new posts to Web Interface 820 to render for the user. HTML5 may be utilized to provide additional features, such as geotagging, geotargeting, contextual analysis, and the like, as well.

While the above embodiments generally may be used by any computing devices, specific embodiments may be designed or optimized for mobile devices. For example, WebKit powered browsers may display user interfaces optimized for mobile devices (e.g., smartphones, tables, etc.). The WebKit engine may utilize a WebSocket connection in the same fashion as the above described systems. Alternatively, embodiments may be designed as platform specific applications (e.g., iOS, Android, or BlackBerry OS apps).

The embodiments described herein primarily relate to scoring assets and aggregating content from plural social networks. However, this information may be very useful for providing asset management tools. For example, an asset owner may wish to monitor trending information relating to their asset (e.g., Coke may wish to monitor Coke Zero) or a politician may wish to monitor trending information relating to their campaign as well as their opponents' campaigns. Embodiments may offer management tools configured to provide early alerts when various significant events occur that may affect the social media score of the asset. For example, a political candidate may receive an early alert if a post having a significant impact is detected to allow him to prepare a response before the media becomes aware of the post. The alert may include various data about the post, such as the network it was posted on and the user who made the post, so that the owner may take appropriate steps to mitigate damage or to ride the wave of an endorsement. In similar fashion, competitors may wish to receive alerts regarding an asset when a significant social media event occurs to allow an early and strategic response. Embodiments of the system may enable an early warning for candidates, individuals, brands, or any asset. Such monitoring may provide alerts around the clock as soon as a triggering event occurs.

Management tools may also provide comprehensive social media reports showing significant trends relating to an asset over time. For example, a monthly report may show the top five posts that affected the score, graphs of score changes over time, and the like. Businesses may use this information to determine correlations between their significant actions (e.g., product releases, advertising campaigns, endorsements, etc.) and the public's perceptions regarding related assets.

Embodiments may be utilized in an assortment of business or revenue models. In one model, all services for selected assets may be freely available to the public via a web interface for a determined number of assets. For example, aggregated social media, a real-time social media score, and some related statistics may be made available for the hundred assets having the most volume (i.e., being the topic of the most social media posts). Embodiments may also make additional content freely available that may be of particular interest, for example content relating to the 2012 presidential election.

These embodiments may also provide targeted ads relating to the scored assets. Thus, a user attracted to the service to see aggregated social media about an asset as well as the score of the asset may also observe ads specifically targeted to the asset of interest to the user. Such targeted ads may be deployed according to multiple revenue models, such as Cost per Action (“CPA”) (e.g., cost per click-through, lead, sale, etc.), Cost per Impression (“CPI”), and the like. Embodiments may also utilize a Pay per Pose (“PPP”) ad model that allows advertisers to have sponsored social media posts.

Embodiments may also allow customers to pay to have and asset's score and social media relating to the asset publicly available. For example, a customer may pay a monthly fee to allow anyone to see scores and social media relating to their asset to illustrate their confidence in the asset and to create buzz relating to the asset. Embodiments may also allow clients to pay per score (“PPS”). PPS may enable a client to pay small monthly fee for software as a service (“SaaS”) to track, warehouse, and enable a true social media monitoring systems and tools suites.

Embodiments may also allow a customer to pay to privately access scores and other data related to one or more assets. For example, a customer may pay a set periodic fee to have access to scores for five keywords relating to an asset. As an illustration, Mitt Romney's campaign may subscribe to receive real-time scores relating to President Obama, Herman Cain, Rick Perry, Michele Bachmann, and himself. The real-time scores may then provide Mitt with a strategic edge by providing his campaign with an aggregate view of how social media posts are reacting to both his and his opponents' campaigns in real-time. Embodiments may also provide additional data for additional fees, for example trending data, geographical data, data relating to the various issues (e.g., a hybrid score for the assets “Obama” and “jobs” may show that while President Obama may receive a mediocre score altogether, the sentiment for him relating to jobs may be lower), and the like. Some embodiments may also provide direct access to warehoused data relating to the asset to allow for more complex data analysis and mining.

Embodiments may also allow for partnering with social network related entities (e.g., Facebook, Groupon, Twitter, Tumblr, Pandora, Google, etc.) to bring their ads to the social media platform described herein. Embodiments may offer such partners a percentage revenue share or an opportunity to exchange ad visibility for access to social media score data.

Embodiments may also be utilized to provide a mobile and social ad platform. Such a service may work as an add-on or plug-in into a mobile app, allowing publishers to bring ads to their users. Embodiments may provide real-time, contextually appropriate, geotargeted ads by staying on-top of real-time trends.

Embodiments may also provide a real-time messaging platform that can be integrated with any video, photo, news article, or other content on the web. In such a platform, posted messages may be archived and a search engine may be utilized to bring the archived messages to search results. For example, if a user searched for “Steve Jobs” on the real-time messaging platform and CNN were using the platform, the user could see comments about Steve Jobs on CNN directly from the platform's user interface. This could be offered as a free service while generating revenue from targeted ads.

Embodiments may also be utilized to provide “white label” interfaces for TV networks so viewers could see what other fans are saying about a show, movie, game, and the like in real-time. In such embodiments, when a network goes to commercial, so could the platform. In other words, if a user was watching an iPhone commercial on TV, the same company's ads may be displayed on the platform's user interface simultaneously. This may further reinforce the advertiser's message. Embodiments may similarly be deployed with news channels.

Embodiments may also provide an aggregation of channels. A marketplace embodiment may provide aggregated products and coupons from networks such as Facebook, Groupon, Living Social, Amazon, Ebay, and the like to bring real-time sentiment of each of each advertised product while offering an opportunity to purchase directly from the embodiment's interface with a single click. Embodiments may partner with the networks and make a commission for every purchase. Embodiments may also create rewards programs to incentivize customers to return.

Embodiments may also provide a portal for user generated reviews and recommendations. For example, an ecommerce website, such as Amazon or Ebay, may utilize embodiments to incorporate real-time user generated reviews into their electronic catalog. Thus, the ecommerce website may provide users with more in depth information about products, thereby increasing both site traffic (i.e., generating ad revenue) and sales. Possibly more importantly, by utilizing embodiments to provide users with real-time user generated reviews, users may have a better understanding of products prior to purchase and return items less often. This may allow the ecommerce website to avoid substantial operating cost caused by returns. Further, embodiments may utilize sentiment determinations to provide real-time user generated content relating to an asset satisfying certain sentiment requirements. For example, an asset manufacturer may utilize a portal according to an embodiment to incorporate real-time user generated reviews into their website but to only include user generated reviews having at least a threshold sentiment determination.

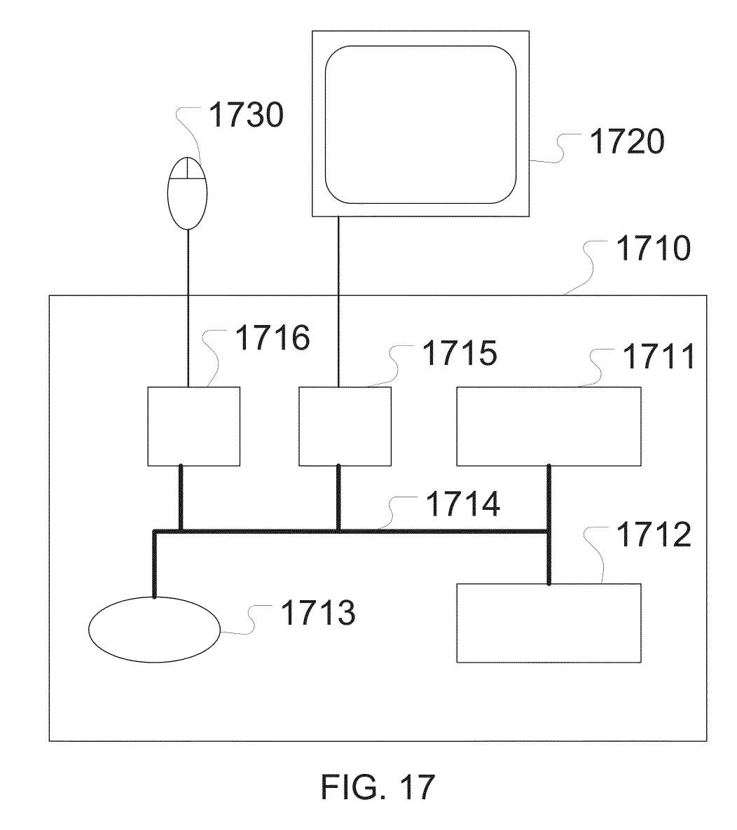

Embodiments described herein may be implemented with software, for example modules executed on computing devices such as computing device 1710 of FIG. 17. Of course, modules described herein illustrate various functionalities and do not limit the structure of any embodiments. Rather the functionality of various modules may be divided differently and performed by more or fewer modules according to various design considerations.

Computing device 1710 has one or more processing device 1711 designed to process instructions, for example computer-readable instructions (i.e., code) stored on a storage device 1713. By processing instructions, processing device 1711 may perform the steps and functions disclosed herein. Storage device 1713 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 1710 additionally may have memory 1712, an input controller 1716, and an output controller 1715. A bus 1714 may operatively couple components of computing device 1710, including processor 1711, memory 1712, storage device 1713, input controller 1716, output controller 1715, and any other devices (e.g., network controllers, sound controllers, etc.). Output controller 1715 may be operatively coupled (e.g., via a wired or wireless connection) to a display device 1720 (e.g., a monitor, television, mobile device screen, touch-display, etc.) in such a fashion that output controller 1715 can transform the display on display device 1720 (e.g., in response to modules executed). Input controller 1716 may be operatively coupled (e.g., via a wired or wireless connection) to input device 1730 (e.g., mouse, keyboard, touch-pad, scroll-ball, touch-display, etc.) in such a fashion that input can be received from a user.

Of course, FIG. 17 illustrates computing device 1710, display device 1720, and input device 1730 as separate devices for ease of identification only. Computing device 1710, display device 1720, and input device 1730 may be separate devices (e.g., a personal computer connected by wires to a monitor and mouse), may be integrated in a single device (e.g., a mobile device with a touch-display, such as a smartphone or a tablet, a web-enabled TV, or any other web-enabled device), or any combination of devices (e.g., a computing device operatively coupled to a touch-screen display device, a plurality of computing devices attached to a single display device and input device, etc.). Computing device 1710 may be one or more servers, for example a farm of networked servers, a clustered server environment, or a cloud network of computing devices.

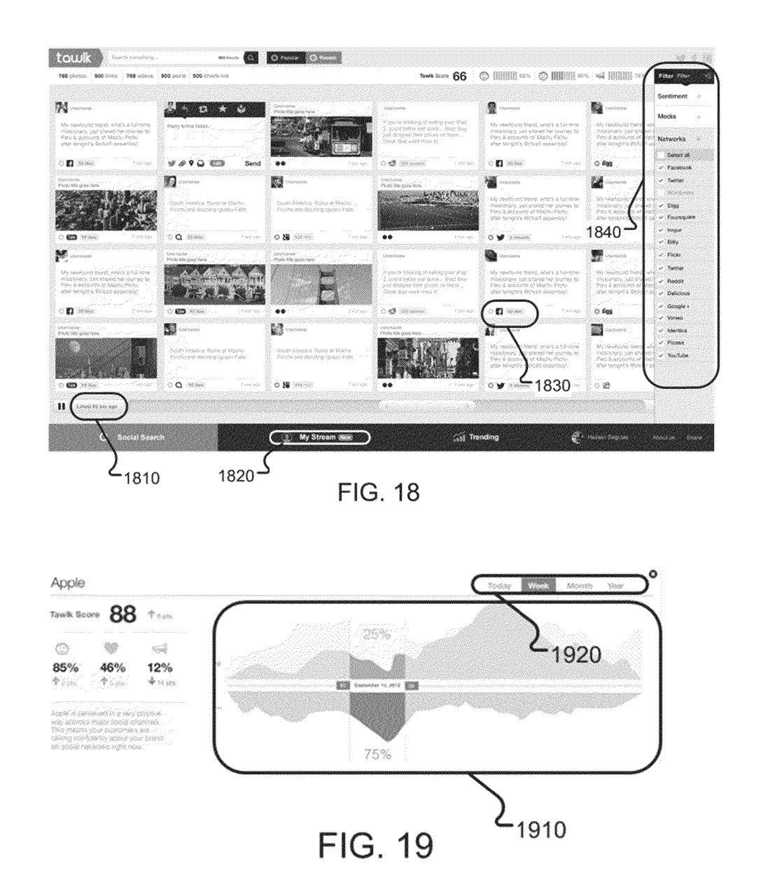

FIG. 18 through 22 illustrates additional exemplary UIs for a social media system. As shown in FIG. 18, a UI may include a control 1810 configured to display in real-time the timing of the newest and oldest post in any given stream. The UI may also include a personalized stream control 1820 configured to allow users to login to one or more social networks and have a continuous stream of updates from all logged-in networks under a single screen. The UI may also include a real-time sentiment classification 1830. The real-time sentiment classification 1830 may include network specific data (e.g., Facebook likes, retweets, upvotes, etc.). The UI may also include a parameterized filter 1840 configured to allow users to filter by parameters such as type of media, sentiment, and social networks.

FIG. 19 illustrates an exemplary UI that includes real-time graphing 1910 that provides a visual display of the social influence of a given asset or topic. Such an interface may also include a navigation control 1920 configured to allow a user to navigate back in time to see social influence data on a specific asset or topic from past time periods (e.g., weeks, months, or years ago).

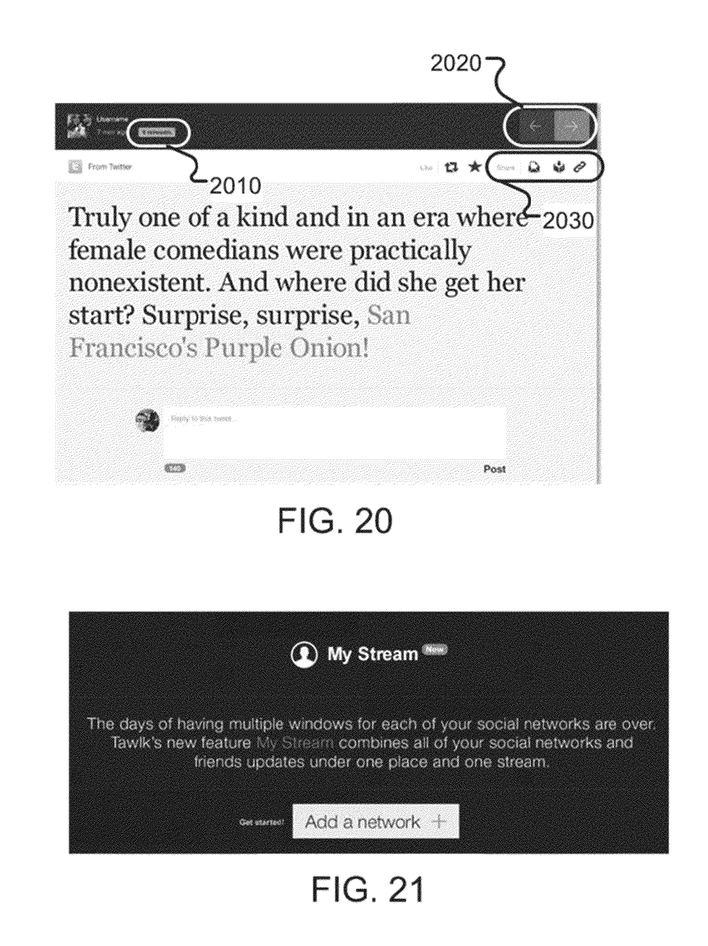

FIG. 20 illustrates an exemplary UI that includes additional controls. A network-specific control 2010 may be included on various posts. In this example, a network-specific control 2010 may be a retweet control for a Twitter tweet. An interface may also include a navigation control 2020 configured to allow a user to navigate through posts and search results chronologically using next and back buttons. An interface may also include sharing controls 2030 configured to allow a user to share a post by email, add it to a Tawlk box, or link directly to the source site.

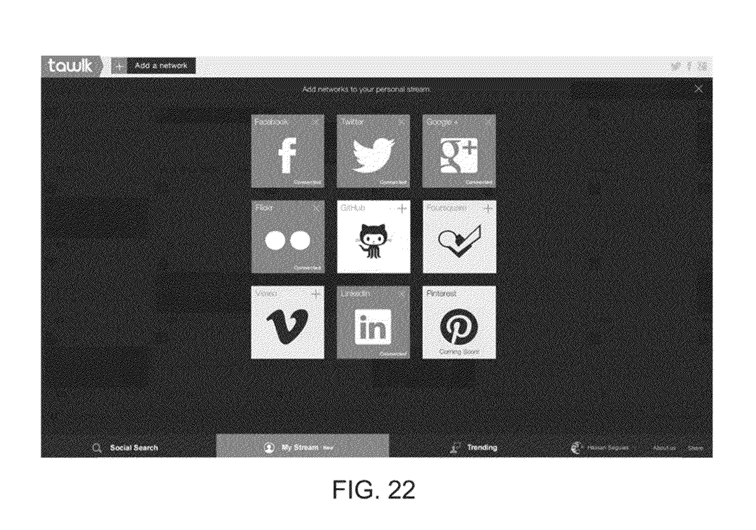

FIGS. 21 and 22 illustrate exemplary personalized stream UIs and related controls. Personal streams, such as “My Stream” shown in these embodiments, may allow users to quickly and easily connect to plural (e.g., all) of their social networks and receive real-time updates from the connected networks under a single stream. A personalized stream may solve the problem and hassle of having multiple windows open while interacting with multiple social networks at the same time. FIG. 22 specifically illustrates exemplary buttons configured to allow a user to connect to various personal social networks.

Embodiments described herein refer to a page being transmitted from a server to a client. Of course, while a webpage may be transmitted to be opened in a browser, in other embodiments a page may be the content transmitted between an application (e.g., an iOS or Android app) and the server. In such embodiments, the application may perform some or all of the functions that may be performed on a server in other embodiments. For example, in an embodiment an application executed on a computing device may perform the functionality of the Tawlk server 810 described with reference to FIG. 8 while the Skor module 812, Synt module 811, and Kral module 813 may still operate on a remote server. Of course, depending on the processing, memory, and bandwidth capabilities of a computing device or group of networked computing devices, any number of functionalities may be performed on the client side rather than on the server side.

Embodiments also generally refer to posts when referring to content received from social networks. Many examples of posts are given throughout this application, such as Facebook posts, Twitter Tweets, Flickr photos, YouTube videos, and blog posts. These examples are not exhaustive. Rather, any content available through APIs may be accessed, aggregated, scored, and or otherwise processed by embodiments disclosed herein.

Additionally, the term API is used herein to generally refer to any method of communications between computing devices. Embodiments are not limited to current interfaces referred to as APIs, but are flexible and may be modified to utilize to-be-developed communications interfaces.

Embodiments have been disclosed herein. However, various modifications can be made without departing from the scope of the embodiments as defined by the appended claims and legal equivalents.

What is claimed is:

1. A method executed by one or more computing devices for generating a social media score comprising:
receiving, by at least one of the one or more computing devices, a request for a score of an asset from a client computing device;
receiving, by at least one of the one or more computing devices, a plurality of posts from one or more social media networks relating to the asset;
identifying, by at least one of the one or more computing devices, a sentiment of each post;
identifying, by at least one of the one or more computing devices, a reach of each post;
storing, by at least one of the one or more computing devices, an identification of the asset, the sentiment of the post, and the reach of the post in association with each post in a dataset;
generating, by at least one of the one or more computing devices, a score for the asset, the score being a function of the sentiment the posts relating to the asset, the reach of the posts relating to the asset, and a volume of posts relating to the asset; and
transmitting, by at least one of the one or more computing devices, the score to the client computing device for display in a user interface.

2. The method of claim 1, wherein the step of generating the score includes:
calculating, for each post relating to the asset, a product of the sentiment of the post and the reach of the post; and
averaging the products of the sentiments of the posts relating to the asset.

3. The method of claim 1, wherein the step of generating the score includes determining an assetscore according to the formula:
$$AssetScore = 100 * \frac{arctan ( \frac{{\sum }_{p ∈ P} synt ( p ) * reach ( p )}{c * ( time ( {p}_{f} ) - time ( {p}_{0} ) )} ) + \frac{π}{2}}{π}$$
where P is a set of all posts p relating to the asset, p_{f} is the first post in set P, p₀ is the last post in set P, synt(p) is a function for determining the sentiment of post p, reach(p) is a function for determining the reach of post p, time(p) is a function for determining the time of post p, and c is a constant.

4. The method of claim 1, further comprising:
transmitting one of the posts and the sentiment of the post to a third party for validation;
receiving a validation indication from the third party;
adjusting the sentiment of the post in the dataset if the validation indication adjusts the sentiment; and
incrementing a validation identifier for the post if the validation indication does not adjust the sentiment.

5. The method of claim 4, further comprising flagging the post as valid once the validation identifier has been incremented a threshold number of times for the post,
wherein the step of generating the score only utilizes posts flagged as valid.

6. The method of claim 1, further comprising:
transmitting, to the client computing device, a page configured to cause the client computing device to:
transmit requests from the client computing device to the one or more social media networks;
receive the plurality of posts from the one or more social media networks;
normalize the plurality of posts; and
transmit to at least one of the one or more computing devices the plurality of posts.

7. The method of claim 6, wherein the page is further configured to cause the client computing device to render in the user interface the plurality of posts.

8. A system for generating a social media score comprising:
a memory; and
a processor operatively coupled to the memory, the processor configured to perform the method:
receiving a request for a score of an asset from a client computing device;
receiving a plurality of posts from one or more social media networks relating to the asset;
identifying a sentiment of each post;
identifying a reach of each post;
storing an identification of the asset, the sentiment of the post, and the reach of the post in association with each post in a dataset;
generating a score for the asset, the score being a function of the sentiment the posts relating to the asset, the reach of the posts relating to the asset, and a volume of posts relating to the asset; and
transmitting the score to the client computing device for display in a user interface.

9. The system of claim 8, wherein the step of generating the score includes:
calculating, for each post relating to the asset, a product of the sentiment of the post and the reach of the post; and
averaging the products of the sentiments of the posts relating to the asset.

10. The system of claim 8, wherein the step of generating the score includes determining an assetscore according to the formula:
$$AssetScore = 100 * \frac{arctan ( \frac{{\sum }_{p ∈ P} synt ( p ) * reach ( p )}{c * ( time ( {p}_{f} ) - time ( {p}_{0} ) )} ) + \frac{π}{2}}{π}$$
where P is a set of all posts p relating to the asset, p_{f} is the first post in set P, p₀ is the last post in set P, synt(p) is a function for determining the sentiment of post p, reach(p) is a function for determining the reach of post p, time(p) is a function for determining the time of post p, and c is a constant.

11. The system of claim 8, the processor further configured to perform the method:
transmitting one of the posts and the sentiment of the post to a third party for validation;
receiving a validation indication from the third party;
adjusting the sentiment of the post in the dataset if the validation indication adjusts the sentiment; and
incrementing a validation identifier for the post if the validation indication does not adjust the sentiment.

12. The system of claim 1, the processor further configured to perform the step of flagging the post as valid once the validation identifier has been incremented a threshold number of times for the post,
wherein the step of generating the score only utilizes posts flagged as valid.

13. The system of claim 8, the processor further configured to perform the method:
transmitting, to the client computing device, a page configured to cause the client computing device to:
transmit requests from the client computing device to the one or more social media networks;
receive the plurality of posts from the one or more social media networks;
normalize the plurality of posts; and
transmit to at least one of the one or more computing devices the plurality of posts.

14. The system of claim 13, wherein the page is further configured to cause the client computing device to render in the user interface the plurality of posts.

15. A non-transitory computer-readable medium having computer-readable code stored thereon that, when executed by a computing device, performs a method for generating a social media score, the method comprising:
receiving a request for a score of an asset from a client computing device;
receiving a plurality of posts from one or more social media networks relating to the asset;
identifying a sentiment of each post;
identifying a reach of each post;
storing an identification of the asset, the sentiment of the post, and the reach of the post in association with each post in a dataset;
generating a score for the asset, the score being a function of the sentiment the posts relating to the asset, the reach of the posts relating to the asset, and a volume of posts relating to the asset; and
transmitting the score to the client computing device for display in a user interface.

16. The medium of claim 15, the method further comprising:
calculating, for each post relating to the asset, a product of the sentiment of the post and the reach of the post; and
averaging the products of the sentiments of the posts relating to the asset.

17. The medium of claim 16, wherein the step of generating the score includes determining an assetscore according to the formula:
$$AssetScore = 100 * \frac{arctan ( \frac{{\sum }_{p ∈ P} synt ( p ) * reach ( p )}{c * ( time ( {p}_{f} ) - time ( {p}_{0} ) )} ) + \frac{π}{2}}{π}$$
where P is a set of all posts p relating to the asset, p_{f} is the first post in set P, p₀ is the last post in set P, synt(p) is a function for determining the sentiment of post p, reach(p) is a function for determining the reach of post p, time(p) is a function for determining the time of post p, and c is a constant.

18. The medium of claim 15, the method further comprising:
transmitting one of the posts and the sentiment of the post to a third party for validation;
receiving a validation indication from the third party;
adjusting the sentiment of the post in the dataset if the validation indication adjusts the sentiment; and
incrementing a validation identifier for the post if the validation indication does not adjust the sentiment.

19. The medium of claim 15, the method further comprising:
flagging the post as valid once the validation identifier has been incremented a threshold number of times for the post,
wherein the step of generating the score only utilizes posts flagged as valid.

20. The medium of claim 19, the method further comprising:
transmitting, to the client computing device, a page configured to cause the client computing device to:
transmit requests from the client computing device to the one or more social media networks;
receive the plurality of posts from the one or more social media networks;
normalize the plurality of posts; and
transmit to at least one of the one or more computing devices the plurality of posts,
wherein the page is further configured to cause the client computing device to render in the user interface the plurality of posts.
